(19) United States
(12) Patent Application Publication
(10) Pub. No.: US 2024/0083007 A1
(43) Pub. Date: Mar. 14, 2024

(54) SANDER WITH BATTERY PACK PLATFORM ORIENTATION

(71) Applicant: TECHTRONIC CORDLESS GP, Anderson, SC (US)

(72) Inventors: Nicholas S. Norton, Anderson, SC (US); Jesse J. Jerabek, Easley, SC (US); Kenneth M. Brazell, Piedmont, SC (US); Garrett Long, West Union, SC (US); Jacob S. Watrous, Piedmont, SC (US); Mason A. Matlock, Mauldin, SC (US); Isiah Daniel Smith, Greenville, SC (US)

(21) Appl. No.: 17/931,794

(22) Filed: Sep. 13, 2022

(51) Int. Cl. B25F 5/02; B24B 23/06

(52) U.S. Cl. CPC B25F 5/02; B24B 23/06

(57) ABSTRACT

A sander includes a housing defining a front end and a rear end relative to a direction of travel of the sander on a work surface, an actuator, and a battery platform. The housing supports a motor and has a grip disposed over the motor adjacent the front end and a handle positioned at or adjacent the rear end. The housing further supports a belt drive assembly configured to rotatably support a belt and having a belt plate extending a long a first plane. The actuator is supported by the handle. The battery platform is at least partially supported by and located above the handle. The battery platform defines a battery pack receptacle configured to support a battery pack. The battery platform is oriented along a second plane orientated at an acute angle relative to the first plane.

### FIELD

The present disclosure relates to a sander, and more particularly to an orientation of a battery pack platform on a belt sander.

### BACKGROUND

Sanders are used to smooth surface of a wood workpiece. Sanders can be used to remove excess glue and rough edges to improve the quality of the surface. Belt sanders are a type of sander that has a sanding belt wrapped around rollers.

### SUMMARY

The present disclosure provides, in one aspect, a sander including a housing defining a front end and a rear end relative to a direction of travel of the sander on a work surface, an actuator, and a battery platform. The housing supports a motor and has a grip disposed over the motor adjacent the front end and a handle positioned at or adjacent the rear end. The housing further supports a belt drive assembly configured to rotatably support a belt and having a belt plate extending a long a first plane. The actuator is supported by the handle. The battery platform is at least partially supported by and located above the handle. The battery platform defines a battery pack receptacle configured to support a battery pack. The battery platform is oriented along a second plane orientated at an acute angle relative to the first plane.

The present disclosure provides, in another aspect, a sander including a motor, a housing supporting the motor, an actuator, and a battery platform. The housing defines a front end and a rear end relative to a direction of travel of the sander on a work surface. The housing includes a grip and a handle. The housing also supports a belt drive assembly configured to rotatably support a belt and having a belt plate that extends along a first plane. The actuator is supported by the handle. The battery platform is at least partially supported by and located above the handle. The battery platform defines a battery pack receptacle configured to support a battery pack. The battery platform defines a first end and a second end. The first end of the battery platform is disposed forward of a center of gravity of the sander relative to the direction of travel. The second end of the battery platform is disposed rearward of the center of gravity of the sander relative to the direction of travel.

The present disclosure provides, in yet another aspect a sander including a motor, a housing supporting the motor, an actuator, and a battery platform. The housing defines a front end and a rear end relative to a direction of travel of the sander on a work surface. The housing includes a grip and a handle. The housing also supports a belt drive assembly configured to rotatably support a belt and having a belt plate that extends along a first plane. The actuator is supported by the handle. The battery platform is at least partially supported by and located above the handle. The battery platform defines a battery pack receptacle configured to support a battery pack. The battery platform defines a first end and a second end. The first end is located adjacent to the grip and the second end is opposite the first end. The battery platform further defines a first battery pack support and a second battery pack support. The second battery pack support is oriented substantially perpendicular to the first battery pack support. The first battery pack support is configured to hold the battery pack on the housing and the second battery pack support is configured to electrically connect the battery pack to the motor. The second battery pack support is located closer to the first end than the second end.

Other features and aspects of the instant disclosure will become apparent by consideration of the following detailed description and accompanying drawings.

### BRIEF DESCRIPTION OF THE DRAWINGS

FIG. 1 is a perspective view of a belt sander in accordance with an embodiment of the disclosure.

FIG. 2 is another perspective view of the belt sander of FIG. 1 with the battery removed.

FIG. 3 is a front view of the belt sander of FIG. 2.

FIG. 4 is a rear view of the belt sander of FIG. 2.

FIG. 5A is a side view of the belt sander of FIG. 2.

FIG. 5B is a corresponding view of FIG. 5 with the battery attached to the sander.

FIG. 6A is another side view of the of the belt sander of FIG. 2.

FIG. 6B is a corresponding view of FIG. 6A with the battery attached to the sander.

FIG. 6C is a corresponding view of FIG. 6 showing the bottom of the sander with a section of the belt removed.

FIG. 7 is a top view of the belt sander of FIG. 2.

FIG. 8 is a cross-sectional view of the belt sander in FIG. 2.

FIG. 9 is another cross-sectional view the belt sander in FIG. 2.

FIG. 10 is a side view of the belt sander in FIG. 2 with part of the housing removed.

Before any embodiments of the instant disclosure are explained in detail, it is to be understood that the disclosure is not limited in its application to the details of construction and the arrangement of components set forth in the following description or illustrated in the following drawings. The subject matter of the instant disclosure is capable of other embodiments and of being practiced or of being carried out in various ways. Also, it is to be understood that the phraseology and terminology used herein is for the purpose of description and should not be regarded as limiting.

### DETAILED DESCRIPTION

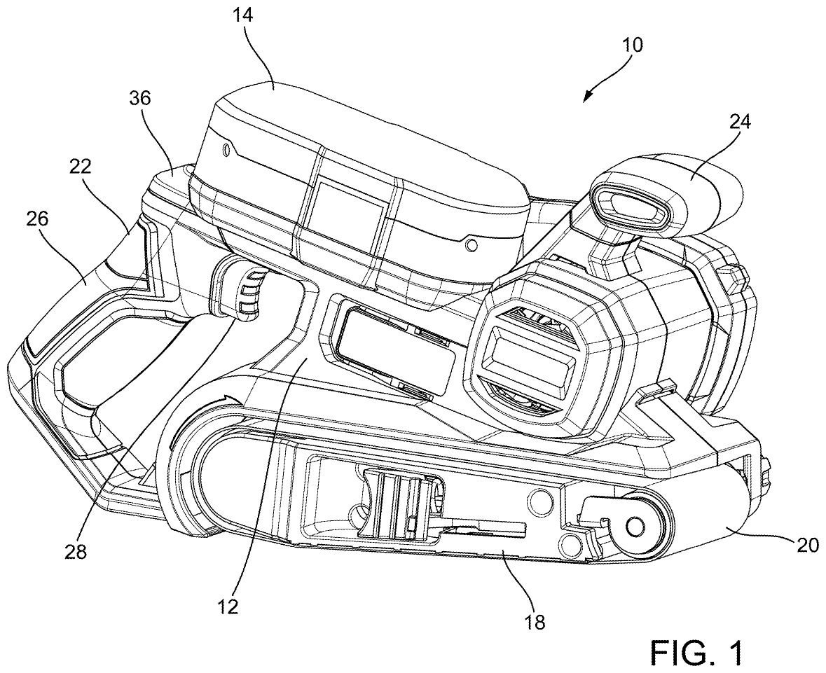

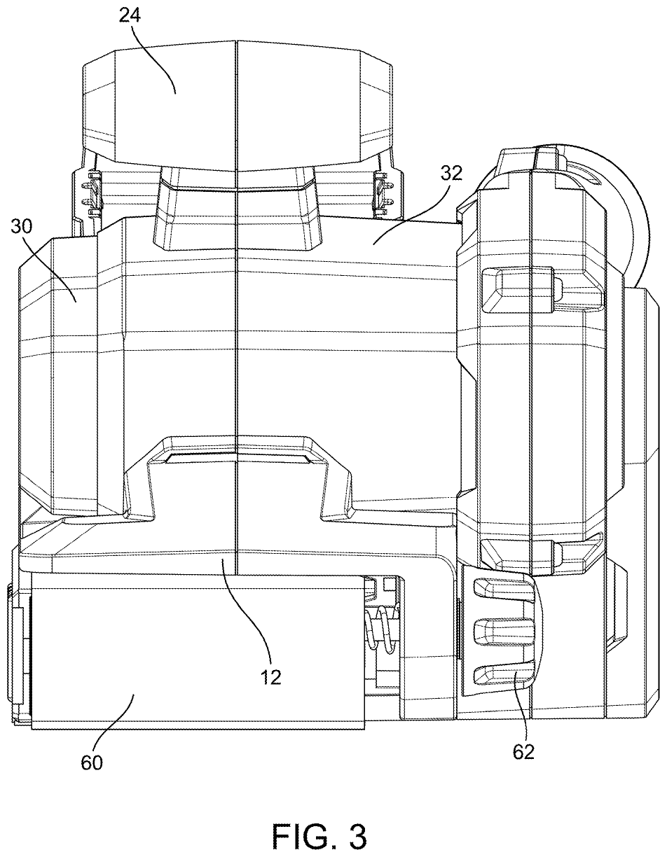

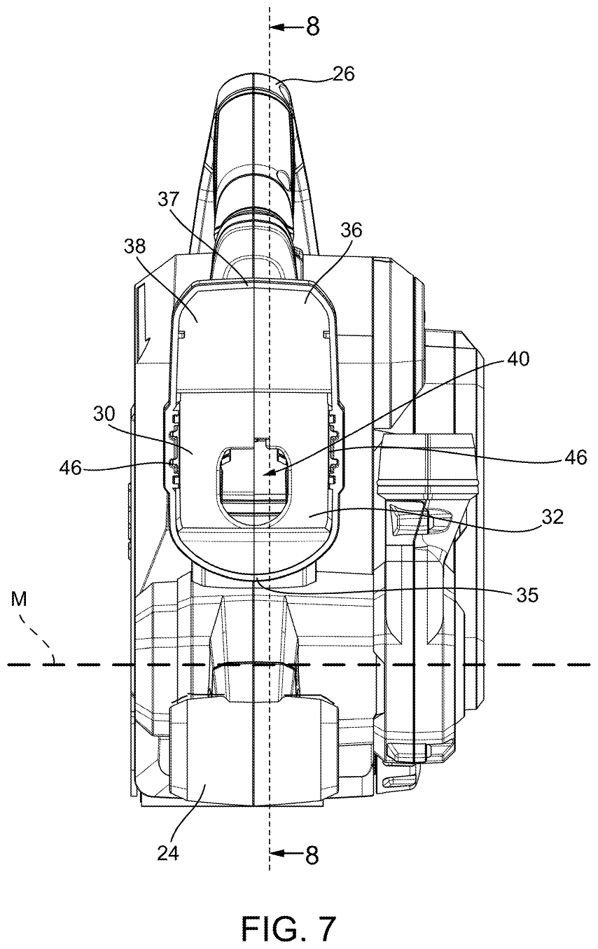

FIGS. 1-10 illustrate an exemplary sander 10 that includes a housing 12, a battery pack 14, a drive assembly 16 (e.g., a belt-driven assembly) supported by the housing 12, and a baseplate 18. The sander 10 is in an upright position when the baseplate 18 is located at a bottom of the sander 10 (e.g., as viewed in FIGS. 3-6). The sander 10 is configured to be manually moved across the work surface to smooth the work surface, and the baseplate 18 has a plane a baseplate plane B (e.g., a first plane) that extends through the baseplate 18 and is generally parallel to the work surface that is being sanded.

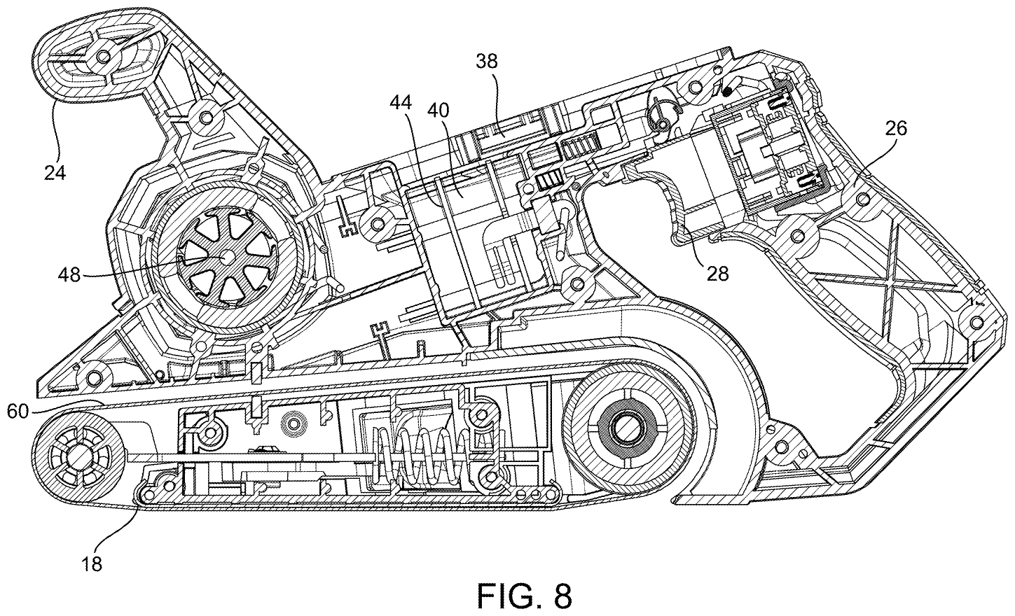

The housing 12 defines a front end 20 (e.g., on the right side of the sander 10 when viewed in FIG. 1) and a rear end 22 (e.g., on the left side of the sander 10 when viewed in FIG. 1) of the sander 10 relative to a direction of travel of the sander 10 over or along the work surface. The housing 12 includes a grip 24. The grip 24 may be disposed adjacent to the front end 20 of the housing 12 (e.g., over a motor 48 of the sander 10, as shown in FIG. 8) and on a top portion of the housing 12 at a location that is opposite the baseplate 18 when the sander 10 is oriented on a horizontal work surface (e.g., as viewed in FIGS. 3-6). As persons having skill in the art will appreciate, disposing the grip 24 at other locations on or over the housing 12 are contemplated. As shown in FIGS. 1 and 3-6B, the grip 24 may extend upward beyond the rest of the housing 12 and may form the highest part of the housing 12 relative to a work surface on which the sander 10 rests. In some embodiments, the grip 24 may be the highest part of the sander 10 when the battery pack 14 is installed, although in other embodiments the battery pack 14 may define the highest part of the sander 10 when the battery pack 14 is installed. The grip 24 defines a plane G (e.g., a horizontal plane) that extends horizontally through the grip 24. The grip 24 may be knob-shaped to allow a user to grasp the grip 24 and to apply a downward force on the grip 24, although other shapes and/or sizes are contemplated. The user may grasp the grip 24 with a first hand and apply a downward force on the grip 24 to ensure that the baseplate 18 of the sander 10 stays in contact with the work surface during a sanding operation.

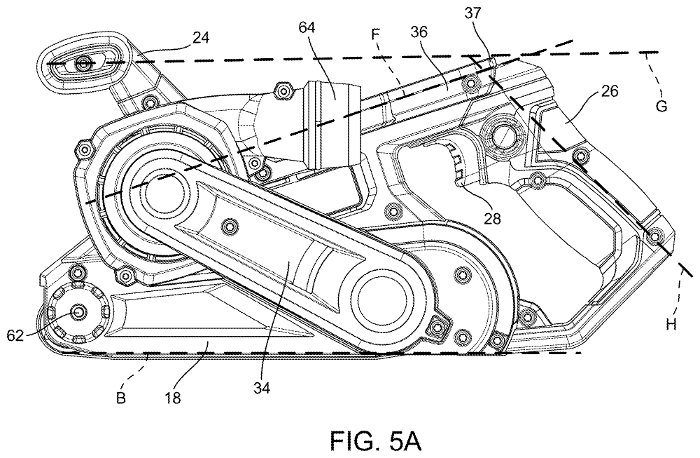

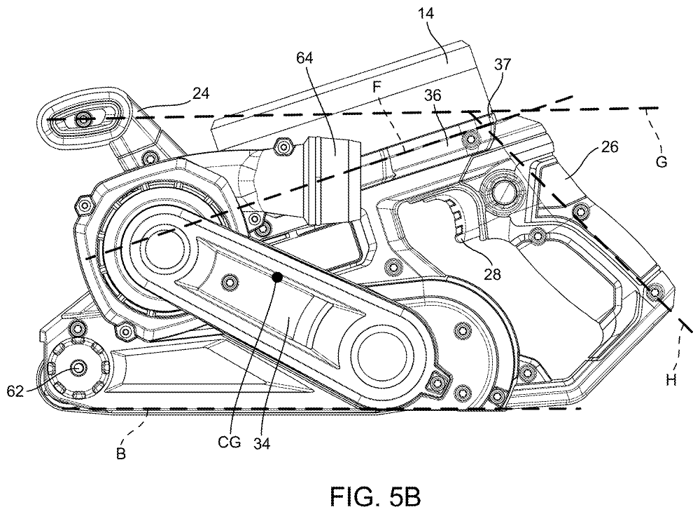

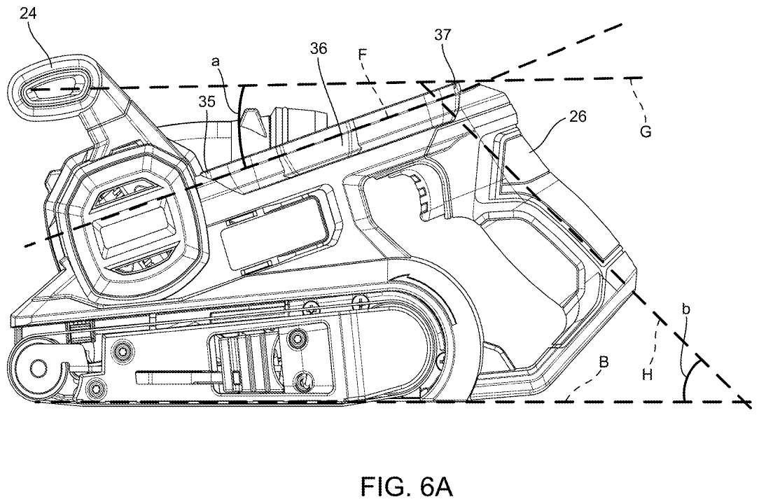

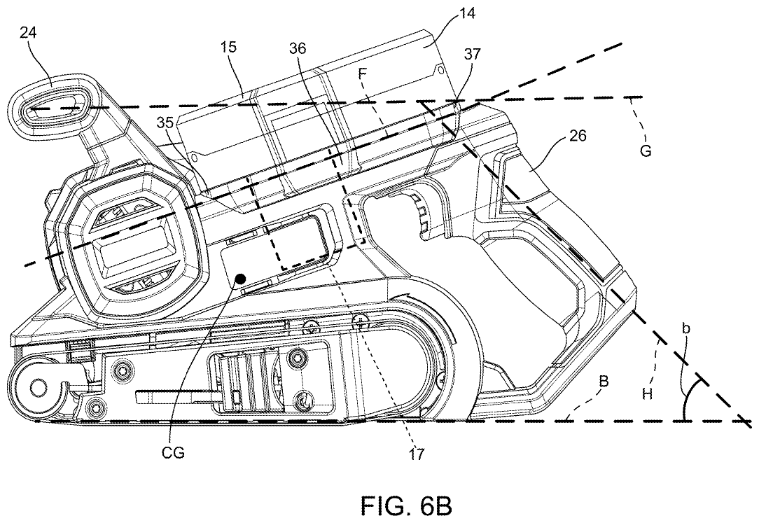

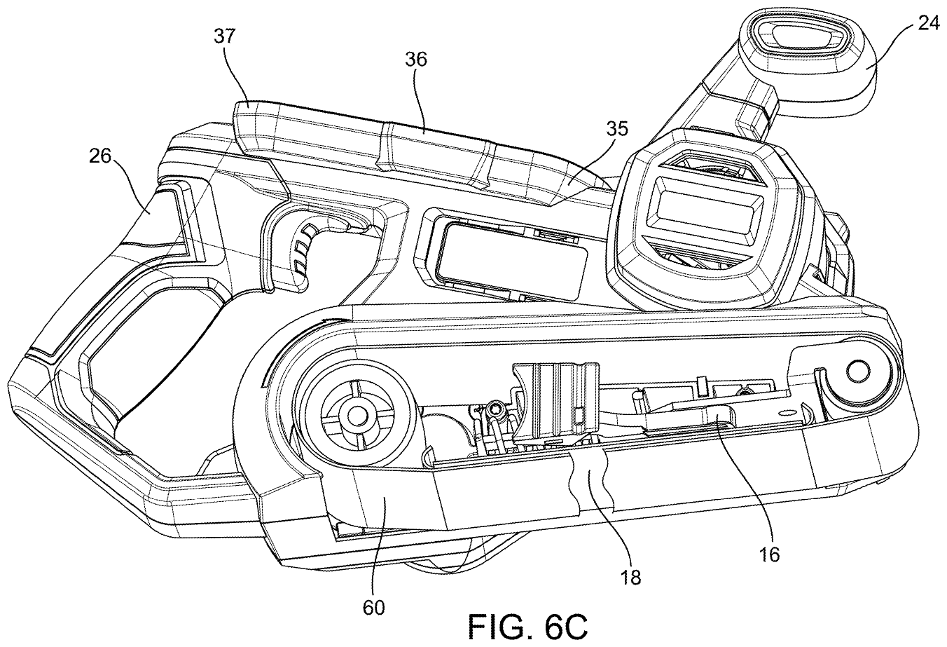

The housing 12 also includes a handle 26 that is located at or adjacent to the rear end 22 of the sander 10 and opposite the grip 24 in a longitudinal direction of the sander 10. As best shown in FIGS. 5A-6B, the handle 26 may extend generally upward and forward (i.e., toward the front end 20) along an axis that defines a handle plane H. As shown, the handle plane H and the baseplate plane B define an angle b (e.g., a handle angle) that is between approximately 30 degrees and 80 degrees, although the angle b may be outside this range. The illustrated handle 26 may include what is referred to as a “pistol grip” style handle that can be grasped by the user's second hand to urge and/or move the sander 10 across the work surface. Either or both the grip 24 and the handle 26 may be used to carry the sander 10. The handle 26 may support a trigger 28 (e.g., an actuator) that functions as the on/off switch for the sander 10 and that may also control a speed of the drive assembly 16. The trigger 28 may be positioned on the handle 26 such that the user can grip the handle 26 and simultaneously use a finger to actuate the trigger 28 in a one-handed fashion.

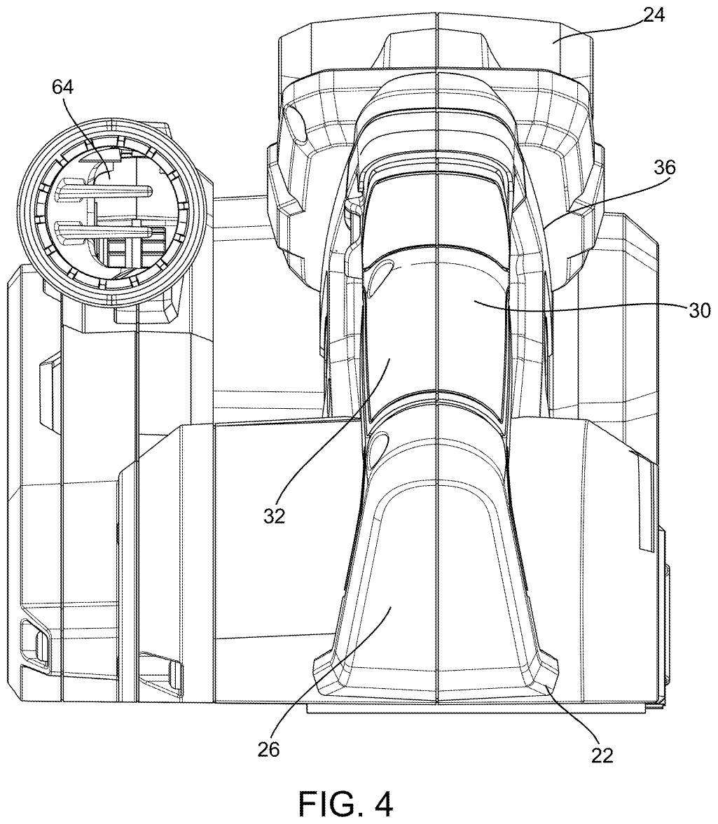

Referring to FIG. 4, the illustrated housing 12 may be defined by a split-housing that has a first housing portion 30, a second housing portion 32, and a drive housing portion 34. As shown in FIGS. 3 and 4, the first housing portion 30 and the second housing portion 32 bisect the main portion of the sander 10. A battery platform 36 is defined by the first housing portion 30 and the second housing portion 32, although the battery platform 36 may be defined by only the first housing portion 30 or the second housing portion 32. The drive housing portion 34 may be adjacent to the second housing portion 32 and supports the drive assembly 16. The drive housing portion 34 is separate from the first and second housing portions 30, 32 such that the user can remove the drive housing portion 34 to perform maintenance on the drive assembly 16 without separating the remainder of the housing 12. The drive housing portion 34 may include an optional dust port 64.

The battery platform 36 defines a battery pack receptacle that supports the battery pack 14 and is located between the grip 24 and the rear end 22 of the housing 12. The battery platform 36 may be at least partially supported by and located above the handle 26. The battery platform 36 is oriented along a plane F (e.g., a second plane). The plane F may be orientated at an acute angle relative to the base plate plane B. The acute angle may be a downward angle toward the work surface relative to the direction of travel of the sander 10. The acute angle may be approximately between 20 degrees and 40 degrees, although the acute angle may be outside this range. The plane F may be oriented at an angle relative to the handle plane H. The angle may be approximately between 80 degrees and 1110 degrees, although the angle may be outside this range.

With reference to FIGS. 5B and 6B, the sander 10 has a center of gravity CG located between the grip 24 and the handle 26 and below a centerline of the motor 48. The grip 24 is located a first horizontal distance from the center of gravity CG (as viewed in FIGS. 5B and 6B), and the handle 26 is located a second horizontal distance from the center of gravity CG (as viewed in FIGS. 5B and 6B). The first distance is different than the second distance. As shown, the first distance is shorter than the second distance such that the center of gravity CG is located horizontally closer to the grip 24 than the handle 26.

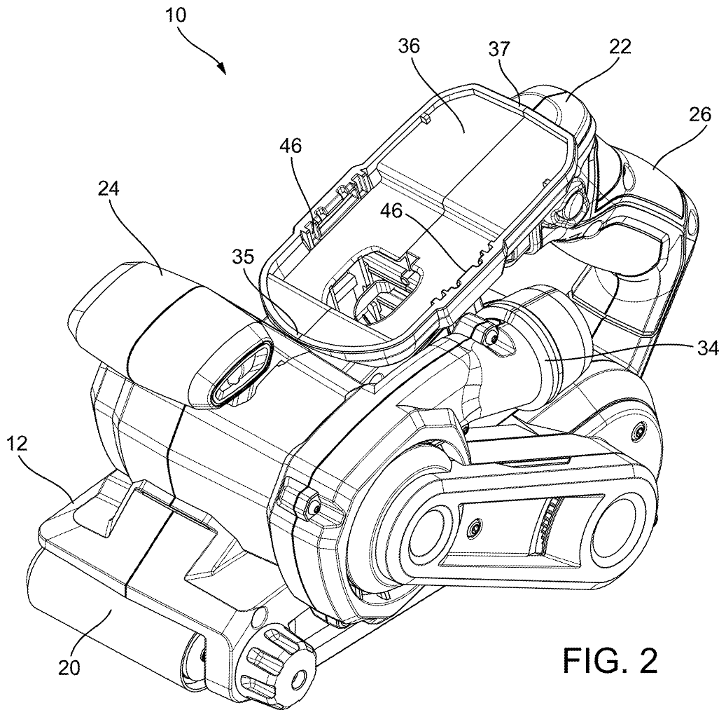

With reference to FIGS. 2, 5A-6B, the battery platform 36 includes a first end 35 and a second end 37 opposite the first end 35. The first end 35 may be located adjacent to the grip 24. The second end 37 may be located adjacent to the handle 26. As shown in FIGS. 6A and 6B, the first end 35 of the battery platform 36 may be disposed forward of the center of gravity CG of the sander 10 and the second end 37 of the battery platform 36 may be disposed rearward of the center of gravity CG of the sander 10 relative to the direction of travel of the sander 10. The center of gravity CG may be located below the first end 35 of the battery platform 36.

When the sander 10 is in the upright position (e.g., when the sander 10 is oriented on a horizontal work surface), the first end 35 may be located below the second end 37. The first end 35 of the battery platform 36 can be disposed below the plane G that extends through the grip 24 such that the first end 35 is disposed between the plane G and the work surface. In some constructions, the entirety of the battery platform 36 may be below the plane G extending through the grip 24 such that the entirety of the battery platform 36 is disposed between the plane G and the work surface.

As shown in FIG. 6B, the battery pack 14 has a main body 15 and a column 17 (e.g., a stem) that extends from the main body 15. The column 17 may be perpendicular to the main body 15. The column 17 includes engagement members that electrically connect with the sander 10. The main body 15 and, in some constructions the column 17, includes recesses or channels that are configured to engage with guides on the battery platform 36 to hold the battery pack 14 in place. The battery pack 14 is removable and supplies power to the sander 10. The battery pack 14 may be an 18V battery pack and include a plurality of individual battery cells. Battery packs with other voltages and number of individual cells are contemplated (e.g., 12V packs, 20V packs, and/or the like).

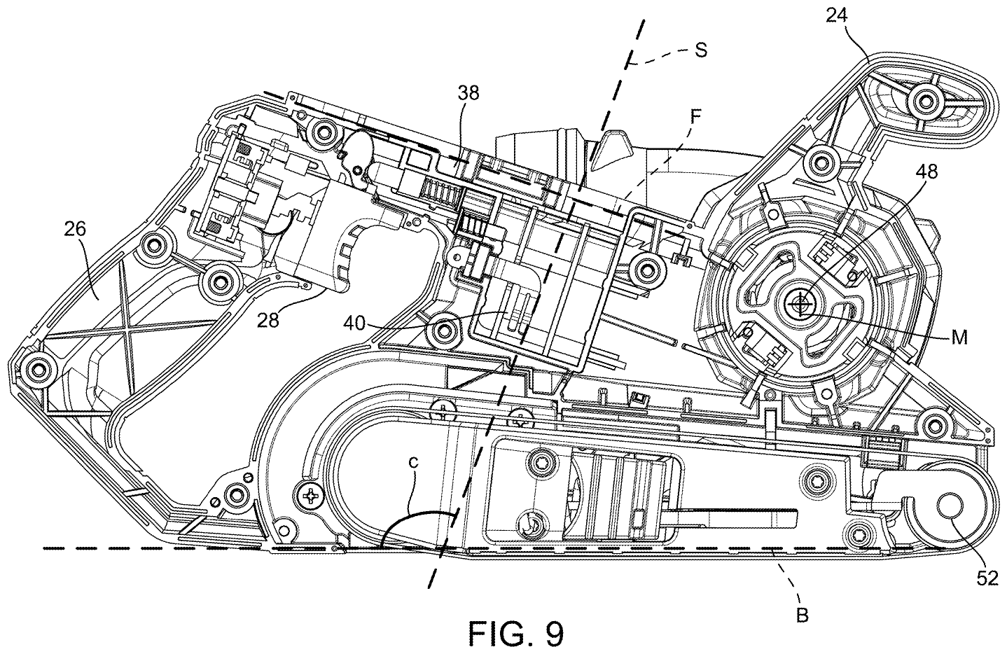

With reference to FIGS. 8 and 9, the battery platform 36 includes a first support section 38 and a second support section 40 (e.g., a stem recess) that is oriented substantially perpendicular to the first support section 38. The first support section 38 is disposed on the top of the housing 12 and extends along the plane F. The first support section 38 is configured to receive the main body 15 of the battery pack 14 and is shaped to correlate to the shape of the main body 15 of the battery pack 14. The first support section 38 may include latches 46 (e.g., clips or opposite guides) on sides of the battery platform 36 that secure the battery pack 14 to the first support section 38 and the housing 12.

The second support section 40 defines a pocket that extends into the housing 12 and has walls that support and receive the column 17 of the battery pack 14. The second support section 40 includes a battery engagement member that electrically connects the battery pack 14 to the motor 48. The second support section 40 may be located closer to the first end 35 of the battery platform 36 than the second end 37 of the battery platform 36. The second support section 40 extends along an axis that defines a second support plane S. The second plane S defines a non-zero angle c (FIG. 9) relative to the baseplate plane B or any horizontal plane when the sander 10 is in the upright position. More specifically, the angle c is an obtuse angle that may range between 110 and 130 degrees, although the angle c may be outside this range. As shown in FIG. 8, the second support section 40 also has guides 44 that extend along the length of the second support section 40 to engage with recesses on the battery pack 14. The guides 44 ensure that the column 17 of the battery pack 14 has a secure fit in the second support section 40. The guides 44 also ensure that the battery pack 14 is inserted into the battery platform 36 in the correct manner.

The battery pack 14 can be attached to the battery platform 36 by aligning the column 17 of the battery pack 14 with the second support section 40. The user can then insert the battery pack 14 by pushing downward (i.e., toward the baseplate 18). The guides 44 ensure that the column 17 of the battery pack 14 is correctly aligned. After the column 17 of the battery pack 14 is fully disposed in the second support section 40, the main body 15 of the battery pack 14 is fully engaged with the first support section 38. The latches 46 secure the battery pack 14 to the battery platform 36. The user may remove the battery pack 14 from the battery platform 36 by unlatching the latches 46 and pulling the battery pack 14 generally upward (i.e., away from the baseplate 18).

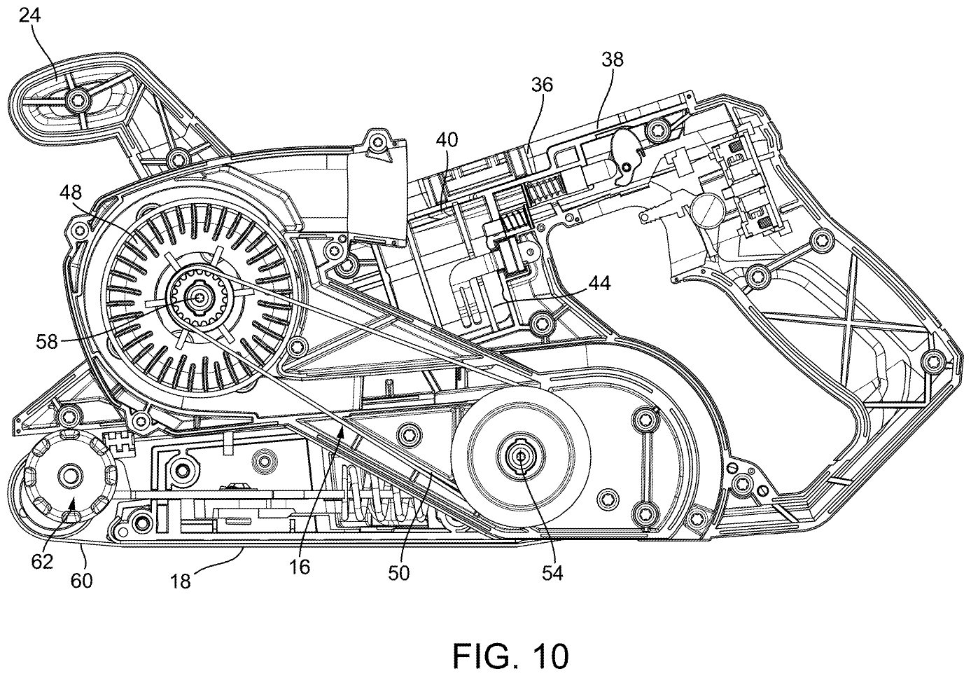

As shown in FIGS. 9-10, the drive assembly 16 may include the motor 48, a belt 50, at least a first pulley 52, and at least a second pulley 54. The drive assembly 16 rotatably supports a sandpaper sheet or a sandpaper belt 60 (e.g., sander belt). The motor 48 may be supported by the housing 12 and be disposed below the grip 24 such that the motor 48 is located between the grip 24 and the work surface. The motor 48 has a drive shaft 58 with an axis of rotation M that is disposed below the battery platform 36 when the sander 10 is in the upright position. In some embodiments, the drive shaft 58 axis of rotation M is parallel, or substantially parallel (i.e., within +/−10 degrees of being parallel) to the baseplate plane B and is below the first plane F when the sander 10 is in the upright position. The center of gravity CG may be located vertically between the drive shaft 58 axis of rotation M and the base plate plane B. The center of gravity CG may also be located behind the motor 48 such that the center of gravity CG is between the motor 48 and the handle 26.

The drive shaft 58 actuates, drives, or otherwise causes the second pulley 54 to rotate via the belt 50, which wraps around the drive shaft 58 and the second pulley 54. The belt 50 is in tension such that the rotational energy of the drive shaft 58 is transferred to the second pulley 54. In operation, the belt 50 rotates when the drive shaft 58 is rotated by the motor 48. As the belt 50 is rotated, the second pulley 54 is driven in rotation. The first pulley 52 and the second pulley 54 are disposed adjacent the bottom of the sander 10 when the sander 10 is in the upright position, and the first pulley 52 is adjacent to the front end 20 and the second pulley 54 is adjacent to the rear end 22. The second pulley 54 may be larger than the first pulley 52. The second pulley 54 and the first pulley 52 are rotatably coupled to each other by the sandpaper belt 60 which is located on the bottom portion of the sander 10 when the sander 10 is orientated on the work surface. The sandpaper belt 60 is wrapped around the baseplate 18 (see FIG. 6C). The baseplate 18 maintains a level support surface for the sandpaper belt 60 on the work surface. That is, the baseplate plane B is parallel to the work surface, which helps keep the sandpaper belt 60 parallel to the work surface. The sander 10 also may include a manual knob 62. The manual knob 62 allows the user to manually rotate the sandpaper belt 60 about the first and second pulleys 52, 54 and the baseplate 18.

The battery platform 36 has a low-profile design such that a large section of the battery pack 14 is disposed on the housing 12 to facilitate a smaller, more compact sander 10 having a lower center of gravity CG (shown in FIGS. 5A-6A). Because the sander 10 has a lower center of gravity CG, the sander 10 becomes easier to store, carry, and manipulate during sanding operations.

A sander includes a housing defining a front end and a rear end relative to a direction of travel of the sander on a work surface, an actuator, and a battery platform. The housing supports a motor and has a grip disposed over the motor adjacent the front end and a handle positioned at or adjacent the rear end. The housing further supports a belt drive assembly configured to rotatably support a belt and having a belt plate extending a long a first plane. The actuator is supported by the handle. The battery platform is at least partially supported by and located above the handle. The battery platform defines a battery pack receptacle configured to support a battery pack. The battery platform is oriented along a second plane orientated at an acute angle relative to the first plane.

The angle is a downward angle toward the work surface relative to the direction of travel of the sander.

The battery platform is disposed between the grip and the rear end of the housing.

The battery platform includes a first end located adjacent the grip. When the first plane is oriented horizontally, the first end is disposed vertically between the grip and the work surface.

The housing defines a split-housing having a first housing portion and a second housing portion coupled to the first housing portion. The battery platform is defined by the first housing portion and the second housing portion.

The battery platform includes a battery stem recess extending into the housing perpendicular to the second plane.

The battery platform further includes opposite guides configured to hold the battery pack on the battery platform.

The handle extends along an axis defining a handle plane. The handle plane is oriented at an angle to the second plane. The angle is between 80 degrees and 110 degrees.

The acute angle is approximately between 20 degrees and 40 degrees.

A sander includes a motor, a housing supporting the motor, an actuator, and a battery platform. The housing defines a front end and a rear end relative to a direction of travel of the sander on a work surface. The housing includes a grip and a handle. The housing also supports a belt drive assembly configured to rotatably support a belt and having a belt plate that extends along a first plane. The actuator is supported by the handle. The battery platform is at least partially supported by and located above the handle. The battery platform defines a battery pack receptacle configured to support a battery pack. The battery platform defines a first end and a second end. The first end of the battery platform is disposed forward of a center of gravity of the sander relative to the direction of travel. The second end of the battery platform is disposed rearward of the center of gravity of the sander relative to the direction of travel.

The handle extends along an axis defining a handle plane. The handle plane is oriented at an angle to the first plane. The angle is between 30 and 80 degrees.

The motor has a drive shaft extending along a drive axis. The center of gravity is located vertically between the drive axis and the first plane.

The sander further includes a first horizontal distance between the grip and the center of gravity and a second horizontal distance between the handle and the center of gravity. The first horizontal distance is different than the second horizontal distance.

The first horizontal distance is smaller than the second horizontal distance.

The first end of the battery platform is disposed between a horizontal plane extending through the grip and the work surface.

A sander includes a motor, a housing supporting the motor, an actuator, and a battery platform. The housing defines a front end and a rear end relative to a direction of travel of the sander on a work surface. The housing includes a grip and a handle. The housing also supports a belt drive assembly configured to rotatably support a belt and having a belt plate that extends along a first plane. The actuator is supported by the handle. The battery platform is at least partially supported by and located above the handle. The battery platform defines a battery pack receptacle configured to support a battery pack. The battery platform defines a first end and a second end. The first end is located adjacent to the grip and the second end is opposite the first end. The battery platform further defines a first battery pack support and a second battery pack support. The second battery pack support is oriented substantially perpendicular to the first battery pack support. The first battery pack support is configured to hold the battery pack on the housing and the second battery pack support is configured to electrically connect the battery pack to the motor. The second battery pack support is located closer to the first end than the second end.

The grip is located at a top portion of the sander and the belt is located at a bottom portion of the sander when the sander is oriented on the work surface. The first end is located below the second end.

The battery platform is oriented along a second plane oriented at an acute angle relative to the first plane.

The handle extends along an axis defining a handle plane. The handle plane is oriented at an angle to the second plane. The angle is between 80 degrees and 110 degrees.

The housing defines a split-housing having a first housing portion and a second housing portion coupled to the first housing portion. The battery platform is defined by the first housing portion and the second housing portion.

While the disclosure has been presented with respect to a limited number of embodiments, those skilled in the art, having benefit of this disclosure, will appreciate that other embodiments may be devised which do not depart from the scope of the present disclosure. Accordingly, the scope of the invention should be limited only by the attached claims.

1. A sander comprising:
a motor;
a housing supporting the motor and defining a front end and a rear end relative to a direction of travel of the sander on a work surface, the housing including a grip disposed over the motor adjacent the front end and a handle positioned at or adjacent the rear end, the housing further supporting a belt drive assembly configured to rotatably support a belt and having a belt plate extending along a first plane;
an actuator supported by the handle; and
a battery platform at least partially supported by and located above the handle, the battery platform defining a battery pack receptacle configured to support a battery pack,
wherein the battery platform is oriented along a second plane oriented at an acute angle relative to the first plane.

2. The sander of claim 1, wherein the acute angle is a downward angle toward the work surface relative to the direction of travel of the sander.

3. The sander of claim 1, wherein the battery platform is disposed between the grip and the rear end of the housing.

4. The sander of claim 3, wherein the battery platform includes a first end located adjacent the grip, and wherein when the first plane is oriented horizontally, the first end is disposed vertically between the grip and the work surface.

5. The sander of claim 1, wherein the housing defines a split-housing having a first housing portion and a second housing portion coupled to the first housing portion, and wherein the battery platform is defined by the first housing portion and the second housing portion.

6. The sander of claim 1, wherein the battery platform includes a battery stem recess extending into the housing perpendicular to the second plane.

7. The sander of claim 6, wherein the battery platform further includes opposite guides configured to hold the battery pack on the battery platform.

8. The sander of claim 1, wherein the handle extends along an axis defining a handle plane, the handle plane oriented at an angle to the second plane, the angle is between 80 degrees and 110 degrees.

9. The sander of claim 1, wherein the acute angle is approximately between 20 degrees and 40 degrees.

10. A sander comprising:
a motor;
a housing supporting the motor and defining a front end and a rear end relative to a direction of travel of the sander on a work surface, the housing including a grip disposed over the motor adjacent the front end and a handle positioned at or adjacent the rear end, the housing supporting a belt drive assembly configured to rotatably support a belt and having a belt plate extending along a first plane;
an actuator supported by the handle; and
a battery platform defining a battery pack receptacle configured to support a battery pack, the battery platform having a first end and a second end,
wherein the first end of the battery platform is disposed forward of a center of gravity of the sander relative to the direction of travel, and
wherein the second end of the battery platform is disposed rearward of the center of gravity of the sander relative to the direction of travel.

11. The sander of claim 10, wherein the handle extends along an axis defining a handle plane, the handle plane oriented at an angle to the first plane, the angle is between 30 and 80 degrees.

12. The sander of claim 10, wherein the motor has a drive shaft extending along a drive axis, and the center of gravity is located vertically between the drive axis and the first plane.

13. The sander of claim 10, further comprising a first horizontal distance between the grip and the center of gravity and a second horizontal distance between the handle and the center of gravity, wherein the first horizontal distance is different than the second horizontal distance.

14. The sander of claim 13, wherein the first horizontal distance is smaller than the second horizontal distance.

15. The sander of claim 10, wherein the first end of the battery platform is disposed between a horizontal plane extending through the grip and the work surface.

16. A sander comprising:
a motor;
a housing supporting the motor and defining a front end and a rear end relative to a direction of travel of the sander on a work surface, the housing including a grip and a handle, the housing supporting a belt drive assembly configured to rotatably support a belt and having a belt plate extending along a first plane;
an actuator supported by the handle; and
a battery platform at least partially supported by and located above the handle, the battery platform defining a battery pack receptacle configured to support a battery pack, the battery platform defining a first end and a second end, the first end located adjacent to the grip, the second end is opposite the first end,
wherein the battery platform further defines a first battery pack support and a second battery pack support, the second battery pack support oriented substantially perpendicular to the first battery pack support, the first battery pack support configured to hold the battery pack on the housing and the second battery pack support configured to electrically connect the battery pack to the motor, and
wherein the second battery pack support is located closer to the first end than the second end.

17. The sander of claim 16, wherein the grip is located at a top portion of the sander and the belt is located at a bottom portion of the sander when the sander is oriented on the work surface and wherein the first end is located below the second end.

18. The sander of claim 16, wherein the battery platform is oriented along a second plane oriented at an acute angle relative to the first plane.

19. The sander of claim 18, wherein the handle extends along an axis defining a handle plane, the handle plane oriented at an angle to the second plane, the angle is between 80 degrees and 110 degrees.

20. The sander of claim 16, wherein the housing defines a split-housing having a first housing portion and a second housing portion coupled to the first housing portion, and wherein the battery platform is defined by the first housing portion and the second housing portion.
